(19) United States
(12) Patent Application Publication
(10) Pub. No.: US 2023/0395783 A1
(43) Pub. Date: Dec. 7, 2023

(54) ALKALINE DRY BATTERY

(71) Applicant: Panasonic Intellectual Property Management Co., Ltd., Osaka-shi, Osaka (JP)

(72) Inventor: Yasufumi Takahashi, Hyogo Ken (JP)

(73) Assignee: Panasonic Intellectual Property Management Co., Ltd., Osaka-shi, Osaka (JP)

(21) Appl. No.: 18/266,960

(22) PCT Filed: Aug. 5, 2021
(86) PCT No.: PCT/JP2021/029088

§ 371 Date: Jun. 13, 2023

(30) Foreign Application Priority Data
Dec. 21, 2020 (JP) 2020-211670

(51) Int. Cl. H01M 4/24; H01M 50/46; H01M 50/183

(52) U.S. Cl. CPC H01M 4/244; H01M 50/46; H01M 50/183; H01M 2004/027

(57) ABSTRACT

An alkaline dry battery includes a bottomed cylindrical case, a hollow cylindrical positive electrode that is in contact with the case from inside, a negative electrode filled in a hollow portion of the positive electrode, and including a negative electrode active material including zinc, a separator disposed between the positive electrode and the negative electrode, an alkaline electrolyte included in the positive electrode, the negative electrode, and the separator, and a sealing unit covering an opening of the case, wherein an additive is charged in a gap between the negative electrode and the sealing unit, and/or a gap between the negative electrode and a bottom portion of the case, and the additive includes an organic acid having a melting point of 90° C. or more.

### TECHNICAL FIELD

The present disclosure relates to an alkaline dry battery.

### BACKGROUND ART

Alkaline dry batteries (alkaline manganese dry batteries) have been widely used because of their large capacity as compared to those of manganese dry batteries and a large current that can be drawn therefrom.

Patent Literature 1 has proposed, in an inside-out type structure alkaline dry battery, disposing a resin swollen with an electrolyte on the positive electrode mixture and gel zine at the positive electrode can opening side. Patent Literature 2 has proposed including terephthalic acid having a specific particle size in the gel negative electrode. In this manner, an internal short circuit can be suppressed when a strong impact is applied to the battery.

### CITATION LIST

### Patent Literature

PLT1: Japanese Laid-Open Patent Publication No. H10-275624

PLT2: WO2018/066204

### SUMMARY OF INVENTION

For alkaline dry batteries, suppression of temperature increase at the time of external short circuit and further improvement in safety are demanded.

An aspect of the present disclosure relates to an alkaline dry battery including: a bottomed cylindrical case, a hollow cylindrical positive electrode that is in contact with the case from inside, a negative electrode filled in a hollow portion of the positive electrode, and including a negative electrode active material including zinc, a separator disposed between the positive electrode and the negative electrode, an alkaline electrolyte included in the positive electrode, the negative electrode, and the separator, and a sealing unit covering an opening of the case.

Wherein an additive is charged in a gap between the negative electrode and the sealing unit, and/or a gap between the negative electrode and a bottom portion of the case, and the additive includes an organic acid having a melting point of 90° C. or more.

With the present disclosure, the temperature increase at the time of external short circuit in alkaline dry batteries can be suppressed.

### BRIEF DESCRIPTION OF DRAWINGS

FIG. 1 is a front view, partially shown in cross section, of an alkaline dry battery in one embodiment of the present disclosure.

FIG. 2 is a front view, partially shown in cross section, of an alkaline dry battery in another embodiment of the present disclosure.

### DESCRIPTION OF EMBODIMENTS

An alkaline dry battery of the embodiment of the present disclosure includes a bottomed cylindrical case, a hollow cylindrical positive electrode that is in contact with the case from inside, a negative electrode filled in the hollow portion of the positive electrode, a separator disposed between the positive electrode and the negative electrode, an alkaline electrolyte, and a sealing unit covering an opening of the case. The negative electrode includes a negative electrode active material containing zinc. The alkaline electrolyte is included in the positive electrode, negative electrode, and separator. An additive is charged in a gap between the negative electrode and the sealing unit, and/or a gap between the negative electrode and a bottom portion of the case, and the additive includes an organic acid having a melting point of 90° C. or more. The above-described melting point means, for example, a value measured by a general method described in Japanese Industrial Standards (JIS K0064) and the like.

When the temperature inside the battery increases by external short circuit, an organic acid charged next to the negative electrode starts to melt and diffuses into the negative electrode, and organic acid efficiently supplies protons to the electrolyte in the negative electrode, and along with this, the hydroxide ion concentration in the electrolyte in the negative electrode decreases. In this manner, an tetrahydroxidozincate ion (II) ([Zn(OH)₄]²⁻) in the negative electrode decreases, zinc oxide (ZnO) deposits to cover the negative electrode active material surface, elusion reactions of zinc, i.e., discharge reaction of the negative electrode, is hindered, and occurrence of short circuit electric current and a temperature increase along therewith are suppressed. By decreasing the hydroxide ion concentration in the negative electrode at the time of external short circuit in this manner, the temperature increase at the battery (surface) at the time of external short circuit is effectively suppressed.

Meanwhile, during normal usage (storage) of batteries, the above-described organic acid is present as a solid, and diffusion of the organic acid (decrease in the hydroxide ion concentration in the negative electrode) into the negative electrode is suppressed, and desired discharge performance can be achieved.

By charging the additive in the above-described gap, absorption of the electrolyte (or swelling along therewith) is hardly caused. The additive charged in a predetermined gap in the battery preferably does not include the electrolyte substantially. Most of the organic acid is not forming a salt with electrolyte derived alkali metals, and is charged in a state capable of supplying protons effectively in the negative electrode at the time of external short circuit. A molar ratio of alkali metal in the additive relative to the organic acid-derived acid group present in the additive is, for example, 1/10 or less (or 1/15 or less).

By charging the additive including the organic acid into a predetermined gap next to the gel negative electrode in the battery, the hydroxide ion concentration in the negative electrode can be decreased at the time of external short circuit. When the organic acid is to be included in the gel negative electrode at the time of negative electrode production, the hydroxide ion concentration cannot be controlled to be low only at the time of short circuit as described above.

When the organic acid has a melting point of 90° ° C.or more, diffusion of the organic acid into the negative electrode is suppressed during normal use of batteries, and the organic acid can be diffused into the negative electrode at the time of external short circuit. In view of battery safety and reliability, the melting point of organic acid may be 100° C. or more, or 100° C. or more and 500° C. or less.

When the organic acid has a melting point of less than 90° C., during normal usage, the organic acid may start to melt and diffuse into the gel negative electrode, and the hydroxide ion concentration cannot be controlled to be low only at the time of short circuit. Also, in this case, the hydroxide ion concentration decreases during normal usage, and discharge performance easily declines.

Examples of the organic acid include organic compounds having an acid group such as a carboxy group and a sulfonic acid group. The organic acid molecule may have an aromatic group, or an aliphatic group. The aromatic group may include, for example, one benzene ring. The aliphatic group may include a straight chain or branched chain hydrocarbon group. The hydrocarbon group may be a saturated hydrocarbon group or an unsaturated hydrocarbon group. A part of hydrogen atoms bonded to carbon atoms of the hydrocarbon group or a part of hydrogen atoms bonded to the aromatic ring may be substituted with a substituent such as a halogen atom. A kind of organic acid may be used singly, or two or more kinds thereof may be used in combination.

Preferably, the organic acid includes a carboxylic acid. The carboxylic acid has, for example, 4 or less carboxyl groups per 1 molecule. Preferably, in view of efficiently supplying protons inside the negative electrode at the time of external short circuit, a carboxylic acid having a plurality of (e.g., 2 to 4) carboxy groups per 1 molecule is used. Preferably, the carboxylic acid includes at least one of a dicarboxylic acid (e.g., succinic acid, adipic acid, isophthalic acid, terephthalic acid), and a tricarboxylic acid (e.g., trimesic acid).

The carboxylic acid may be an aliphatic carboxylic acid or an aromatic carboxylic acid. Examples of the aliphatic carboxylic acid include a compound in which a carboxy group is bonded to both sides of a straight chain saturated hydrocarbon group (e.g., alkylene group with 2 to 4 carbon atoms). For such a compound, for example, succinic acid, glutaric acid, adipic acid, oxalic acid, maleic acid, fumaric acid, tartaric acid, and citric acid are used.

Examples of the aromatic carboxylic acid include a compound in which 1 to 3 carboxyl groups are bonded to one benzene ring. Examples of such a compound include phthalic acid (ortho, meta, para), benzoic acid, benzene tricarboxylic acid (trimesic acid, trimellitic acid), and salicylic acid.

Preferable examples of the carboxylic acid include succinic acid, adipic acid, benzoic acid, isophthalic acid, terephthalic acid, and trimesic acid. A kind of carboxylic acid may be used singly, or two or more kinds thereof may be used in combination.

The amount of the organic acid charged in the predetermined gap in the battery may be, per 1 g of zinc derived from the negative electrode active material, 20 mg or more and 2000 mg or less, or 40 mg or more and 2000 mg or less. When the amount of the organic acid is within the above-described range, the organic acid can be easily charged in the predetermined gap in the battery, and the effects of suppression of the temperature increase at the time of external short circuit by the organic acid can be easily achieved.

The additive may include at least the organic acid, and may also include other components excluding the organic acid. The other components may be a component (e.g., polytetrafluoroethylene) that improves binding capability of the solid organic acid, and may be mixed with a powder of the organic acid. The additive to be charged in a predetermined gap in the battery may be a powder or a pellet. The pellet is obtained by, for example, pressure-molding the powder organic acid or a mixture of the powder organic acid and other components.

Also, in view of suppressing side reactions during normal usage (normal temperature) and suppressing impregnation of the additive with the electrolyte, a thin film (e.g., cellophane) for partial shielding may be disposed between the negative electrode and the additive.

A detailed description will be given below of an alkaline dry battery according to the present embodiment, with reference to the drawing. The present invention, however, is not limited to the following embodiment. Modification can be made as appropriate without departure from the scope in which the effect of the present invention can be exerted. Furthermore, any combination with another embodiment is possible.

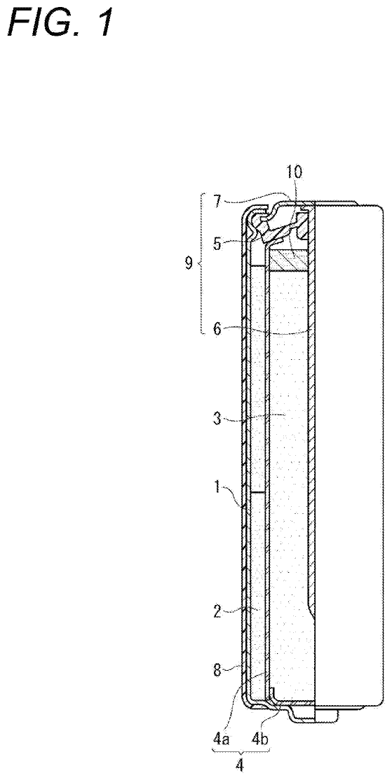

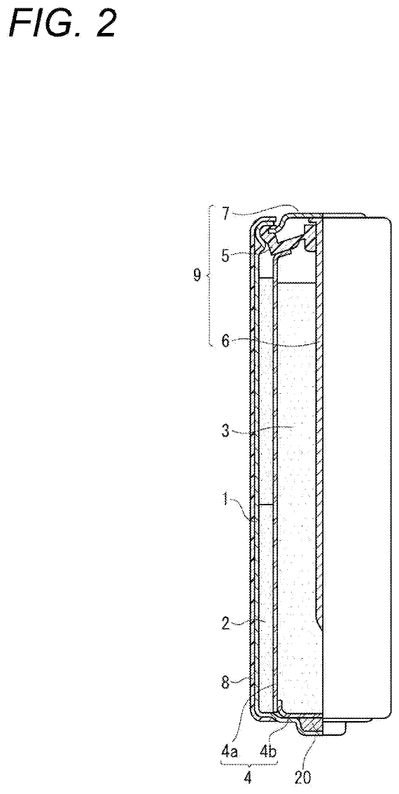

FIG. 1 is a front view of an alkaline dry battery according to one embodiment of the present disclosure, with one half side shown in cross-section. FIG. 2 is a front view of an alkaline dry battery according to another embodiment of the present disclosure, with one half side shown in cross-section. FIG. 1 and FIG. 2 show an example of a cylindrical battery having an inside-out type structure. In FIG. 2, those having the same configuration with FIG. 1 have the same reference numerals.

As illustrated in FIG. 1, the alkaline dry battery includes a power generation element including a hollow cylindrical positive electrode 2, a gel negative electrode 3 disposed in the hollow of the positive electrode 2, a separator 4 interposed therebetween, and an alkaline electrolyte. The power generation element is housed in a bottomed cylindrical metal case 1 serving as a positive electrode terminal. For the case 1, for example, a nickel plated steel plate is used. The positive electrode 2 is disposed in contact with the inner wall of the case 1. Preferably, to improve adherence between the positive electrode 2 and the case 1, the inner surface of the case 1 is covered with a carbon coating.

The bottomed cylindrical separator 4 is constituted of a cylindrically-shaped separator 4a and a bottom paper 4b. The separator 4a is disposed along the inner surface of the hollow of the positive electrode 2, to provide insulation between the positive electrode 2 and the negative electrode 3. The separator disposed between the positive electrode and the negative electrode means the cylindrical separator 4a. The bottom paper 4b is disposed at the bottom of the hollow of the positive electrode 2, to provide insulation between the negative electrode 3 and the battery case 1.

The opening of the case 1 is sealed with a sealing unit 9. The sealing unit 9 includes a resin-made gasket 5, a negative electrode terminal plate 7 also serving as a negative electrode terminal, and a negative electrode current collector 6. The negative electrode current collector 6 is inserted in the negative electrode 3. Materials of the negative electrode current collector 6 include, for example, an alloy containing copper and zinc, such as brass. The negative electrode current collector 6 may be plated with tin or the like, if necessary. The negative electrode current collector 6 has a nail-like shape having a head and a shank, and the shank is passed through a through-hole provided in the center cylindrical portion of the gasket 5. The head of the negative electrode current collector 6 is welded to the flat portion at the center of the negative electrode terminal plate 7.

The opening end of the battery case 1 is crimped onto the flange at the circumference of the negative electrode terminal plate 7, via the peripheral end portion of the gasket 5. The outer surface of the case 1 is wrapped with an outer label 8.

In an alkaline dry battery of this embodiment, an additive 10 including an organic acid having a melting point of 90° C. or more is charged in a gap between the gel negative electrode 3 and the sealing unit 9 (gap formed with the negative electrode 3, the negative electrode current collector 6 (portion thereof exposed from the negative electrode 3) and the gasket 5). The additive 10 may be charged as a ring pellet including an organic acid. In this case, the shank of the negative electrode current collector 6 is disposed at the hollow portion of the pellet. By the additive 10 charged next to the negative electrode 3, the organic acid included in the additive 10 can be quickly diffused into the negative electrode 3 at the time of external short circuit. In view of suppressing impregnation of the additive with the electrolyte in the negative electrode during normal usage, the additive 10 is preferably charged as a pellet. The separator 4a next to the additive 10 retains the electrolyte, and therefore the electrolyte in the separator 4a hardly penetrates into the additive 10.

Furthermore, as shown in FIG. 2, an additive 20 including an organic acid having a melting point of 90° C. or more may be charged in the gap between the gel negative electrode 3 and the bottom portion (gap portion formed by projection of the positive electrode terminal at bottom portion) of the case 1. By the additive 20 charged next to the negative electrode 3 with the bottom paper 4b interposed therebetween, the organic acid included in the additive 20 can be diffused into the negative electrode 3 at the time of external short circuit. The additive 20 may be a powder form or a pellet form. The bottom paper 4 next to the additive 20 retains the electrolyte, and therefore the electrolyte hardly penetrates into the additive 20.

The additive 20 of FIG. 2 can be charged along with the additive 10 of FIG. 1. In view of suppression of side reactions during normal usage (normal temperature) and suppression of penetration of the electrolyte into the additive, a thin film (e.g., cellophane) for partial shielding may be disposed between the gel negative electrode 3 and the additive 10 and/or between the gel negative electrode 3 and the additive 20 (at the position of the bottom paper 4b).

The positive electrode 2 includes manganese dioxide as a positive electrode active material and an electrolyte. The manganese dioxide is preferably an electrolytic manganese dioxide. The manganese dioxide is usually used in a powder form. To easily ensure properties such as the packing density of the positive electrode and the diffusibility of the electrolyte within the positive electrode, the average particle size (D50) of the manganese dioxide is, for example, 20 μm or more and 60 μm or less. In view of moldability and suppression of the positive electrode expansion, manganese dioxide may have a BET specific surface area in a range of, for example, 20 m²/g or more and 50 m²/g or less.

In the present specification, the average particle size (D50) refers to a median diameter in a volumetric particle size distribution. The average particle size can be measured by, for example, using a laser diffraction and/or a scattering type particle size distribution analyzer. Furthermore, the BET specific surface area is obtained by measuring and calculating a surface area using a BET equation, which is a theoretical equation of multilayer adsorption. The BET specific surface area may be determined by, for example, a nitrogen adsorption method using a specific surface area measuring device.

The positive electrode 2 may include, in addition to the manganese dioxide and electrolyte, a conductive agent. Examples of the conductive agent include carbon blacks such as acetylene black, and other conductive carbon materials such as graphite. Some example graphites which may be used are natural graphite and artificial graphite. The conductive agent may be in fibrous state or the like, and is preferably a powder. The average particle size (D50) of the conductive agent can be selected from, for example, a range of 5 nm or more and 50 μm or less. Preferably, the conductive agent has an average particle size (D50) of, when the conductive agent is carbon black, 5 nm or more and 40 nm or less, and when the conductive agent is graphite, 3 μm or more and 50 μm or less. The positive electrode mixture has a conductive agent content of, relative to 100 parts by mass of the manganese dioxide, for example, 3 parts by mass or more and 10 parts by mass or less, and preferably 4 parts by mass or more and 8 parts by mass or less.

The positive electrode 2 can be formed by, for example, compression-molding a positive electrode mixture including a positive electrode active material, a conductive agent, and an alkaline electrolyte into a pellet shape. The positive electrode mixture may be formed into flakes or granules beforehand and classified if necessary, and then compression-molded into a pellet shape. The pellet, after placed into the case, may be secondarily pressed using a predetermined tool so as to be in close contact with the inner wall of the case. In the positive electrode pellet, the average density of manganese dioxide is, for example, 2.78 g/cm³ or more and 3.08 g/cm³ or less. The positive electrode (positive electrode mixture) may contain, as necessary, further other components (e.g., polytetrafluoroethylene).

The negative electrode 3 has a gel form. That is, the negative electrode 3 includes, in addition to the negative electrode active material and electrolyte, generally a gelling agent. The negative electrode active material includes zinc or a zinc alloy. In view of corrosion resistance, the zinc alloy preferably includes at least one selected from the group consisting of indium, bismuth, and aluminum. For the electrolyte, the electrolyte to be included in the positive electrode pellet can be used.

The negative electrode active material is usually used in a powder form. To easily ensure properties such as the packing density of the negative electrode and the diffusibility of the alkaline electrolyte within the negative electrode, the average particle size (D50) of the negative electrode active material powder is, for example, 80 μm or more and 200 μm or less, preferably 100 μm or more and 150 μm or less. In the negative electrode, the negative electrode active material powder content is, for example, 170 parts by mass or more and 220 parts by mass or less relative to 100 parts by mass of the electrolyte.

The gelling agent is not particularly limited and may be any known gelling agent used in the field of alkaline dry batteries, and for example, a water-absorbing polymer or the like may be used. Examples of such gelling agents include polyacrylic acid and sodium polyacrylate. The gelling agent is added by, for example, relative to 100 parts by mass of the negative electrode active material, 0.5 parts by mass or more and 2 parts by mass or less.

For the separator 4, for example, nonwoven fabric or microporous film is used. Examples of the material of the separator include cellulose and polyvinyl alcohol. As the non-woven fabric, for example, one mainly including fibers of these materials is used. As the microporous films, cellophane or the like is used. The separator has a thickness of, for example, 80 μm or more and 300 μm or less. The separator may be formed by placing a plurality of sheets (nonwoven fabric, etc.) on top of another to give the thickness of the above-described range.

In FIG. 1, the bottomed cylindrical separator 4 is formed from a cylindrical separator 4a and a bottom paper 4b, but it is not limited thereto. For the separator, an integrated bottomed cylindrical type may be used, or any known separators used in the field of alkaline dry batteries can be used.

For the electrolyte, for example, an aqueous alkaline solution including potassium hydroxide is used. The potassium hydroxide concentration in the electrolyte is, for example, 30 mass % or more and 50 mass % or less. The electrolyte may further contain zinc oxide. The zinc oxide concentration in the electrolyte is, for example, 1 mass % or more and 5 mass % or less. The electrolyte content in the positive electrode mixture is, relative to 100 parts by mass of manganese dioxide, for example, 4 parts by mass or more and 15 parts by mass or less.

### EXAMPLES

The present disclosure will be more specifically described below with reference to Examples and Comparative Examples; however, the present invention is not limited to the following Examples.

### Example 1

An AA-size cylindrical alkaline dry battery (LR6) as illustrated in FIG. 1 was produced in procedures described below.

### Positive Electrode Production

An electrolytic manganese dioxide powder (average particle size (D50): 35 μm) serving as a positive electrode active material was mixed with a graphite powder (average particle size (D50): 8 μm) serving as a conductive agent, to give a mixture. The mass ratio of the electrolytic manganese dioxide powder to the graphite powder was set to 92.4:7.6. To 100 parts by mass of the mixture, 1.5 parts by mass of an electrolyte was added. The mixture was stirred sufficiently and then compression-molded into a flake form, to give a positive electrode mixture. For the electrolyte, an aqueous alkaline solution including potassium hydroxide (concentration 35 mass%) and zinc oxide (concentration 2 mass%) was used.

The flake form positive electrode mixture was crushed into a granular form, and classified through a 10- to 100-mesh sieve; then, 11 g of the resultant granules were compression-molded into a predetermined hollow cylindrical shape of 13.65 mm in outer diameter, to form a positive electrode pellet 2. Two pellets were produced.

### Negative Electrode Production

A negative electrode active material, an electrolyte, and a gelling agent were mixed, to give a gel negative electrode 3. The negative electrode active material used here was a zinc alloy powder (particle size (D50): 130 μm) containing 0.02 mass % of indium, 0.01 mass % of bismuth, and 0.005 mass % of aluminum. The electrolyte used here was the same as that used for the production of the positive electrode. The gelling agent used here was a mixture of a cross-linked branched polyacrylic acid and a highly cross-linked linear sodium polyacrylate. The mass ratio of the negative electrode active material: electrolyte: gelling agent was set to 100:50:1.

### Alkaline Dry Battery Assembly

Vamiphite available from Nippon Graphite Industries, Ltd. was applied to the inner surface of a bottomed cylindrical battery case (outer diameter: 13.80 mm, wall thickness of cylindrical portion: 0.15 mm, height: 50.3 mm) made of a nickel-plated steel sheet, to form a carbon coating having a thickness of approximately 10 μm. A case 1 was thus obtained. After inserting the two positive electrode pellets vertically into the case 1, the positive electrode pellets were pressurized to form a positive electrode 2 that was in close contact with the inner wall of the case 1. A bottomed cylindrical separator 4 was placed inside the positive electrode 2, and then, an electrolyte was injected thereto, to impregnate the separator 4. The electrolyte used here was the same as that used for producing the positive electrode. These were allowed to stand in this state for a predetermined period of time, to allow the electrolyte to permeate from the separator 4 into the positive electrode 2.

Thereafter, 6 g of the gel negative electrode 3 was packed inside the separator 4. An additive 10 was disposed on the negative electrode 3. For the additive 10, a ring pellet obtained by compression-molding the powder organic acid shown in Table 1 was used. The organic acid was charged by 40 mg per 1 g of zinc in the negative electrode active material.

The separator 4 was constituted of a cylindrically-shaped separator 4a and a bottom paper 4b. The cylindrically-shaped separator 4a and the bottom paper 4b were formed using a sheet of mixed nonwoven fabric (basis weight: 28 g/m²) mainly composed of rayon fibers and polyvinyl alcohol fibers mixed in a mass ratio of 1:1. The thickness of the nonwoven fabric sheet used for the bottom paper 4b was 0.27 mm. The separator 4a was constituted by winding a 0.09-mm-thick nonwoven fabric sheet in three layers.

A negative electrode current collector 6 was obtained by pressing general brass (Cu content: about 65 mass %, Zn content: about 35 mass %) into a nail shape, and plating the surface with tin. The diameter of the body of the negative electrode current collector 6 was 1.15 mm. The head of the negative electrode current collector 6 was electrically welded to a negative electrode terminal plate 7 made of a nickel-plated steel sheet. Then, the shank of the negative electrode current collector 6 was press-inserted into the through-hole provided at the center of a polyamide resin-made gasket 5. In this manner, a sealing unit 9 was produced which was composed of the gasket 5, the negative electrode terminal plate 7, and the negative electrode current collector 6.

Then, the sealing unit 9 was placed at an opening of the case 1. At this time, the shank of the negative electrode current collector 6 was placed inside the hollow portion of the ring pellet (additive 10), and inserted into the negative electrode 3. The opening end of the case 1 was crimped onto the periphery of the negative electrode terminal plate 7, with the gasket 5 interposed therebetween, to seal the opening of the case 1. The outside surface of the case 1 was wrapped with an outer label 8. In this manner, an alkaline dry battery A1 in which an additive was charged in a gap between the negative electrode and the sealing unit was produced.

### Examples 2 to

Batteries A2 to A6 of Examples 2 to 6 were produced in the same manner as the battery A1 of Example 1, except that the compound shown in Table 1 was used as the organic acid.

### Examples 7 to 8

Batteries A7 to A8 of Examples 7 to 8 were produced in the same manner as in the battery A1 of Example 1 and the battery A4 of Example 4, respectively, except that the amount of the organic acid charged was as shown in Table 1.

### Examples 9 to 10

Instead of charging the additive 10, a powder organic acid was charged as the additive 20 to a depressed portion of the case bottom portion. Except for the above, in the same manner as in the batteries A7 to A8 of Examples 7 to 8, batteries A9 to A10(battery as shown in FIG. 2) of Examples 9 to 10 in which an additive was charged in a gap between the negative electrode and the case bottom portion were produced, respectively.

### Comparative Example 1

A battery X1 of Comparative Example 1 was produced in the same manner as in the battery A1 of Example 1, except that the additive (organic acid) was not charged in the gap between the negative electrode and the sealing unit.

### Comparative Examples 2 to 6

Batteries X2 to X6 of Comparative Examples 2 to 6 were produced in the same manner as in the battery A1 of Example 1, except that instead of charging the additive (organic acid) to the gap between the negative electrode and the sealing unit, the compound shown in Table 1 was included in the negative electrode as the organic acid.

### Evaluation

Batteries produced as described above were subjected to surface temperature measurement at the time of external short circuit, and the highest temperature at that time was determined. The evaluation results are shown in Table 1. The amount charged shown in Table 1 is the amount of the organic acid charged (mg) per 1 g of zinc in the negative electrode active material included in the negative electrode.

TABLE 1

| | | | | | Evaluation |
|---|---|---|---|---|---|
| | Additive | | | | Highest |
| | Organic acid | | | | Temperature (° C.) at |
| | | Melting | Amount | | Battery surface in |
| Battery | | point | charged | | external short |
| No. | Type | (° C.) | (mg) | Charged places | circuit |
| A1 | Succinic acid | 182 | 40 | Gap between | 93 |
| A2 | Adipic acid | 146 | 40 | Negative Electrode | 92 |
| A3 | Benzoic acid | 122 | 40 | and sealing unit | 93 |
| A4 | Terephthalic acid | 402 | 40 | | 90 |
| A5 | Isophthalic acid | 345 | 40 | | 87 |
| A6 | Trimesic acid | >300 | 40 | | 85 |
| A7 | Succinic acid | 182 | 2000 | | 84 |
| A8 | Terephthalic acid | 402 | 2000 | | 79 |
| A9 | Succinic acid | 182 | 2000 | Gap between | 92 |
| A10 | Terephthalic acid | 402 | 2000 | Negative Electrode | 90 |
| | | | | and case bottom | |
| X1 | Not added | — | — | Inside Negative | 102 |
| X2 | Succinic acid | 182 | 40 | Electrode | 105 |
| X3 | Adipic acid | 146 | 40 | | 107 |
| X4 | Terephthalic acid | 402 | 40 | | 102 |
| X5 | Isophthalic acid | 345 | 40 | | 103 |
| X6 | Trimesic acid | >300 | 40 | | 101 |

In the batteries A1 to A10 of Examples, the temperature increase at the time of external short circuit was suppressed compared with the batteries X1 to X6 of Comparative Examples. In the batteries A3 to A6, in which aromatic carboxylic acid was used, the highest temperature at the time of external short circuit satisfied relations of A6<A4, A5<A3. In A3, benzoic acid (1 carboxyl group per 1 molecule) was used. In A4 and A5, terephthalic acid and isophthalic acid (2 carboxyl groups per 1 molecule) were used. In A6, trimesic acid (3 carboxyl groups per 1 molecule) was used. The tendency showed that the larger the number of carboxyl groups per 1 molecule of aromatic carboxylic acid, the better the effects of suppressing the temperature increase at the time of external short circuit.

In the battery X1 in which the additive was not charged and the batteries X2 to X6, in which the organic acids were included in the negative electrode, the hydroxide ion concentration in the negative electrode did not decrease at the time of external short circuit, and therefore the battery temperature increased at the time of external short circuit.

### INDUSTRIAL APPLICABILITY

The alkaline dry battery according to the present disclosure can be suitably used as a power source for, for example, portable audio equipment, electronic game players, lights and the like.

### REFERENCE SIGNS LIST

1 case
2 positive electrode
3 negative electrode
4 bottomed cylindrical separator
4a cylindrical separator
4b bottom paper
5 gasket
6 negative electrode current collector
7 negative electrode terminal plate
8 outer label
9 sealing unit
10, 20 additive

1. An alkaline dry battery comprising:
a bottomed cylindrical case,
a hollow cylindrical positive electrode that is in contact with the case from inside,
a negative electrode filled in a hollow portion of the positive electrode, and including a negative electrode active material including zinc,
a separator disposed between the positive electrode and the negative electrode,
an alkaline electrolyte included in the positive electrode, the negative electrode, and the separator, and
a sealing unit covering an opening of the case, wherein
an additive is charged in a gap between the negative electrode and the sealing unit, and/or a gap between the negative electrode and a bottom portion of the case, and
the additive includes an organic acid having a melting point of 90° C. or more.

2. The alkaline dry battery of claim 1, wherein the organic acid includes carboxylic acid.

3. The alkaline dry battery of claim 2, wherein the carboxylic acid has 4 or less carboxy groups per 1 molecule.

4. The alkaline dry battery of claim 2, wherein the carboxylic acid includes at least one selected from the group consisting of succinic acid, adipic acid, benzoic acid, isophthalic acid, terephthalic acid, and trimesic acid.

5. The alkaline dry battery of claim 1, wherein 20 mg or more and 2000 mg or less of the organic acid is included per 1 g of zinc in the negative electrode active material.
